(19) United States
(12) Patent Application Publication
(10) Pub. No.: US 2012/0184685 A1
(43) Pub. Date: Jul. 19, 2012

(54) PACKAGED PEROXIDE FORMULATION

(75) Inventors: Albert Lucas KORVEMAKER, DEVENTER (NL); Frans Johannes HOOGESTEGER, NIJMEGEN (NL); Petrus Paulus WAANDERS, GOOR (NL)

(73) Assignee: AKZO NOBEL N.V., ARNHEM (NL)

(21) Appl. No.: 13/371,561

(22) Filed: Feb. 13, 2012

Related U.S. Application Data
(63) Continuation of application No. 11/996,670, filed on Mar. 17, 2008, now abandoned.
(60) Provisional application No. 60/716,033, filed on Sep. 9, 2005.

(30) Foreign Application Priority Data
Jul. 25, 2005 (EP) 05106787.4

(51) Int. Cl. C08F 8/00; B65D 85/00; B65D 90/34; C08F 4/28

(52) U.S. Cl. 525/387; 526/227; 206/524.1; 206/524.4

(57) ABSTRACT

A packaged peroxide formulation comprising a container and a liquid peroxide formulation, wherein said container has a volume of at least 50 litres and a vent area/volume ratio of at least 20·10⁻³ m²/m³, said liquid peroxide formulation satisfies the classification tests for organic peroxide type F, has a conductivity of at least 100 pS/m, is not an emulsion or suspension, and comprises (i) at least 33 wt % of an organic peroxide selected from the group consisting of diacyl peroxides, peroxyesters, peroxydicarbonates, peroxyketals, and monoperoxycarbonates, and (ii) optionally a phlegmatiser, the packaged peroxide formulation has a vent area that is at least equal to the minimum total vent area as determined by the 10 litre venting test.

The invention relates to a packaged peroxide formulation that can be handled, produced, and shipped in a safe manner and which is suitable for use in polymerisation and polymer modification processes.

Organic peroxides are liable to exothermic decomposition. They can decompose above a certain critical temperature to produce gas and heat. The heat produced promotes further decomposition. The storage and transportation of these compounds is particularly troublesome in that the build-up of decomposition gases in the transportation or storage container may cause violent, hazardous explosions, bursting the container holding the peroxide. In recognition of this problem, international safety laws and standards regulate the transportation and storage of these compounds.

The larger the container, the lower its surface-to-volume ratio, and the more difficult the transmittal of heat to the surroundings in case of thermal decomposition. Hence, storage and transport of peroxides becomes more hazardous when the container volume increases.

In order to improve transportation and storage safety, organic peroxides are generally stored and transported in containers containing the peroxide diluted with one or more liquids, e.g. in the form of a suspension, emulsion, or solution. Aqueous peroxide emulsions or suspensions are generally considered safe formulations, because the peroxide is dispersed in the water phase, which is well suited for the removal of the heat of decomposing peroxide molecules, e.g. by convection and/or evaporation.

The present invention relates to liquid peroxide formulations that are not emulsions or suspensions. These formulations may consist of 100% pure liquid peroxide, but preferably contain a solvent that either dissolves the peroxide (in case of a solid peroxide) or dilutes the peroxide to form a homogeneous liquid (in case of a liquid peroxide). The solvent is also known as phlegmatiser. Classical phlegmatising agents are hydrocarbons and esters, such as phthalates.

The larger the container, the more diluted a peroxide formulation generally needs to be. For instance, t-butyl peroxy-2-ethylhexanoate (Trigonox® 21) is presently transported in 30-litre containers in a concentration up to 100 wt %. However, safety considerations have limited the peroxide concentration in larger tanks to 30 wt % of the peroxide.

The presence of phlegmatiser has several disadvantages. For instance, when the peroxide formulation is used in a polymerisation reaction, the phlegmatiser may end up in the resin that is produced. This is evidently undesired. Further, from an economical viewpoint, it is undesired to transport and store large volumes which contain only a relatively small amount of the actual reagent.

It is therefore an object of the present invention to provide safe transportation and storage of organic peroxides—without being suspended or emulsified—in large containers (a volume of more than 50 litres) in a higher concentration (i.e. at least 33 wt %), thereby decreasing the phlegmatiser content.

This object is achieved by the packaged peroxide formulation according to the present invention, which comprises a container and a liquid peroxide formulation, wherein
said container has a volume of at least 50 litres and a vent area/volume ratio of at least 20·10⁻³ m²/m³,
said liquid peroxide formulation satisfies the classification tests for organic peroxide type F, has a conductivity of at least 100 pS/m, is not an emulsion or suspension, and comprises (i) at least 33 wt % of an organic peroxide selected from the group consisting of diacyl peroxides, peroxyesters, peroxydicarbonates, peroxyketals, and monoperoxycarbonates, and (ii) optionally a phlegmatiser, and
the packaged peroxide formulation has a vent area that is at least equal to the minimum total vent area as determined by the 10 litre venting test.

The container in which the peroxide formulation is packaged has a volume of at least 50 litres, preferably at least 200 litres, more preferably at least 800 litres, and most preferably at least about 1,000 litres. The container volume preferably is not more than 20,000 litres, more preferably not more than 10,000 litres.

The container must have an opening to quickly release the whole container content in case a certain maximum pressure is exceeded, so that an explosion can be avoided. The required size of this opening (the vent area) depends on, e.g., the volume of the container, the material of which the container is made, and the type and concentration of the peroxide that is present in the container. The required minimum vent area for a specific packaged formulation can be determined by the 10 litre venting test as described in Amendment 1 to the 4^{th} revised edition of the Manual of Test and Criteria—ST/SG/AC.10/32/Add.2 (23 Feb. 2005), Appendix 5—of the United Nations Recommendations on the Transport of Dangerous Goods.

The vent area/volume ratio of the container must be at least 20·10⁻³ m²/m³, preferably at least 50·10⁻³ m²/m³, more preferably at least 80·10⁻³ m²/m3, and most preferably at least about 100·10⁻³ m²/m³. For practical reasons, the vent area/volume ratio preferably is not higher than 250·10⁻³ m²/m³, more preferably not higher than 125·10⁻³ m²/m³.

The packaged peroxide formulation according to the present invention is preferably stored and transported at temperatures above −20° C., preferably above −10° C., more preferably above 0° C. The preferred maximum storage and transportation temperature is generally about 50° C.

A further advantage of the packaged peroxide formulation according to the present invention is that ice formation—resulting from the small amount of water that is generally present in peroxide formulations—during storage and transportation at temperatures below 0° C. is reduced. Ice formation may result in blocked and/or frozen valves, which may hamper the container unloading process.

The liquid peroxide formulation must satisfy the classification tests for “organic peroxide Type F”, of the Manual of Tests and Criteria (4^{th} revised edition), Part II, Division 5.2 of United Nations Recommendations on the Transport of Dangerous Goods, resulting in a classification UN 3109 and/or UN 3119. These tests are known to every person skilled in the art of organic peroxide chemistry.

The organic peroxide concentration in the liquid peroxide formulation is at least 33 wt %, preferably at least 35 wt %, more preferably at least 40 wt %, and most preferably at least 45 wt %. The organic peroxide concentration preferably is 90 wt % or less, more preferably 80 wt % or less, even more preferably 70 wt % or less, and most preferably 60 wt % or less. All weight percentages are based on the total weight of the peroxide formulation.

If the organic peroxide concentration is less than 100 wt %, the liquid peroxide formulation also contains a phlegmatiser.

The conductivity of the liquid peroxide formulation is at least 100 pS/m, preferably at least 500 pS/m, more preferably at least 1,000 pS/m, more preferably still at least 2,000 pS/m, even more preferably at least 4,000 pS/m. The conductivity can range up to 100,000 pS/m, if so desired.

This conductivity is measured according to British Standard 5958, part 1:1991 (Appendix A, chapter A.2.3; available from the British Standards Institution), using a voltage of 5 V.

The organic peroxide used in the present invention is selected from diacyl peroxides, peroxyesters, (cycli) perketals, peroxydicarbonates, and monoperoxycarbonates. Hence, the organic peroxide comprises one or more peroxyester groups (of the formula —C(O)OO—), peroxy(di)carbonate groups (of the formula —OC(O)OO—), perketal groups (of the formula —O—Cₙ—OO—), or diacyl peroxide groups (of the formula —C(O)OOC(O)—). Also mixed peroxides (containing any two different peroxygen-bearing moieties in one molecule) and mixtures of two or more of these peroxides can be used. It is noted that if the organic peroxides are not liquid at room temperature, they may be soluble in the phlegmatiser or mixture of phlegmatisers. Although the peroxides can be oligomeric or polymeric in nature, it is preferred that they are of the conventional type comprising one, two or three peroxygen bonds in the molecule. More preferred are (di)peroxyesters and diacyl peroxides. Most preferred are (di)peroxyesters.

Examples of (di)peroxyesters are 1,1,4,4-tetramethylbutyl-1,4-di(peroxy-2-methyl propa noate), tert-butylperoxy neodecanoate, tert-amylperoxy neodecanoate, 1,1,3,3-tetramethyl butyl-1-peroxy neodecanoate, 1,1-dimethyl-3-hydroxy butyl-1-peroxy neodecanoate, tert-butylperoxy pivalate, tert-amylperoxy pivalate, 1,1,3,3-tetramethyl butyl-1-peroxy pivalate, 1,1-dimethyl-3-hydroxy butyl-1-peroxy pivalate, tert-butylperoxy 2-ethyl hexanoate, tert-amyl peroxy 2-ethylhexanoate, 1,1,3,3-tetramethyl butyl-1-peroxy 2-ethylhexanoate, 1,1-dimethyl-3-hydroxy butyl-1-peroxy 2-ethyl hexanoate, tert-butylperoxy benzoate, tert-amylperoxy benzoate, 1,1,3,3-tetramethyl butyl-1-peroxy benzoate, 1,1-dimethyl-3-hydroxy butyl-1-peroxy benzoate, tert-butylperoxy 3,3,5-trimethylhexanoate, tert-amylperoxy 3,3,5-trimethylhexanoate, 1,1,3,3-tetramethyl butyl-1-peroxy 3,3,5-trimethylhexanoate, 1,1-dimethyl-3-hydroxy butyl-1-peroxy 3,3,5-trimethylhexanoate, tert-butylperoxy isobutyrate, tert-amylperoxy isobutyrate, 1,1,3,3-tetramethyl butyl-1-peroxy isobutyrate, and 1,1-dimethyl-3-hydroxy butyl-1-peroxy iso butyrate.

Examples of diacyl peroxides are bis(3,3,5-trimethylhexanoyl) peroxide, dilauroyl peroxide and didecanoyl peroxide.

Examples of peroxydicarbonates are [di(4-tert-butylcyclohexyl) peroxy-dicarbonate, di(2-ethylhexyl) peroxydicarbonate, dibenzoyl peroxide, dicetyl peroxydicarbonate, and dimyristyl peroxydicarbonate.

Examples of monoperoxycarbonates are tert-butylperoxy 2-ethylhexyl carbonate, tert-amylperoxy 2-ethylhexyl carbonate, and tert-butylperoxy isopropyl carbonate.

Examples of (cyclic) peroxyketales are 1,1-di(tert-butylperoxy) cyclohexane,1,1-di(tert-butylperoxy)-3,3,5-trimethylcyclohexa ne,2,2-di(4,4-di(tert-butylperoxy)cyclohexyl)propane, and 3,6,9,-triethyl-3,6,9-trimethyl-1,4,7-triperoxonane.

Suitable phlegmatisers include paraffinic and white oils, n-paraffins, iso-paraffins, aromatic hydrocarbons, and oxygenated hydrocarbons, such as ethers, epoxides, and esters. More specific examples are toluene, xylene, (diesel) fuel, phthalates, adipates, epoxidised soybean oil, n-octane, n-decane, isododecane, and ethylbenzene.

Preferably, the packaged peroxide formulation is essentially free of chlorinated species, since such species may lead to corrosion problems or interfere with the polymerisation process in which the formulations are used as a source of free radicals. Further, the packaged peroxide formulation does not require the use of an antistatic—such as an (in)organic acid or a salt thereof—for reaching the desired conductivity. It is therefore desired that the packaged peroxide formulation does not contain an antistatic. Most preferably, the formulation consists of—meaning: contains nothing more than—organic peroxide and phlegmatiser.

The invention further relates to a method for producing a polymer by means of a radical polymerisation process using organic peroxide as a source of free radicals, which method involves transporting the packaged peroxide formulation according to the invention to a polymerisation unit and introducing the peroxide formulation into the polymerisation process. Examples of such polymerisation processes are processes to make polyvinyl chloride, copolymers of vinyl chloride, poly(meth)acrylate (co)polymers, etc. Preferably, the process is a styrene suspension (co)polymerisation process or a high-pressure ethylene (co)polymerisation process. Comonomers that may be used in the (co)polymerisation process of ethylene are of the conventional type and include alkenes, such as propene, (cyclo)hexene and (cyclo)octene, and vinyl acetate. Comonomers that may be used in the (co)polymerisation process of styrene are of the conventional type and include divinyl benzene. The amount of organic peroxide used in these conventional (co)polymerisation processes will vary, depending on the polymerisation temperature, the capacity for removing the heat of polymerisation, the kind(s) of monomer(s) used, and the applied pressure. Usually, from 0.001-25 wt % of organic peroxide, based on the total weight of the monomers, is employed. Preferably, from 0.001-15 wt % of peroxide is employed.

The invention also relates to a process for modifying a (co)polymer—such as in cross-linking, grafting, and controlled degradation processes, e.g. the formation of polypropylene with another molecular weight and/or molecular weight distribution—by transporting the packaged peroxide formulation according to the invention to a polymer modification unit and introducing the peroxide formulation into the process.

### EXAMPLES

### Example 1

Stainless steel Intermediate Bulk Containers (IBCs) with a volume of 1.25 m³ and a vent area/volume ratio of 100·10⁻³ m²/m³ were filled with the liquid formulations listed below. These formulations contain peroxide—either t-butyl peroxy-2-ethylhexanoate (Trigonox ® 21, ex Akzo Nobel) or t-butyl peroxypivalate (Trigonox® 25, ex Akzo Nobel)—in different concentrations in isododecane. The conductivity of the different formulations was measured according to British Standard 5958, part 1:1991 (Appendix A, chapter A.2.3; available from the British Standards Institution), using a voltage of 5 V.

| | Conductivity (pS/m) | |
|---|---|---|
| Peroxide concentration (wt %) | Trigonox ® 21 | Trigonox ® 25 |
| 15 | 51.6 | 66.0 |
| 30 | 1.65 × 10³ | 2.58 × 10³ |
| 40 | 4.71 × 10⁴ | 1.90 × 10⁴ |
| 50 | 2.75 × 10⁵ | 9.17 × 10⁴ |
| 75 | 9.17 × 10⁵ | |

### Example 2

In order to evaluate their safety in transportation and storage, the 40 wt % Trigonox® 25 and the 50 wt % Trigonox® 21 formulations of Example 1 were tested using the 10 litre venting test according to the 4^{th} revised edition of the Recommendations on the Transport of Dangerous Goods, Manual of Test and Criteria, ST/SG/AC.10/32/Add.2 (23 Feb. 2005), Appendix 5, using a vent area/volume ratio of 100·10⁻³ m²/m³ and heating rates of 0.8 K/min and 0.7 K/min, respectively. The Trigonox® 25 formulation resulted in a maximum recorded pressure of 4.5 barg; the Trigonox® 21 formulation resulted in a maximum recorded pressure of 0 barg.

Since a stainless steel IBC can stand pressures up to 10 barg, these formulations satisfy the 10 litre venting test, i.e. the vent area is at least equal to the minimum total vent area.

Further, the classification tests for “organic peroxide Type F” were performed on these formulations, resulting in a classification of UN 3109 and UN 3119.

### Example 3

Computer model calculations (using ISPRA Relief) were performed to determine the vent area/volume ratio that is required to stand the 10 litre venting test for a stainless steal IBC containing the 40 wt % Trigonox® 25 formulation of Example 1.

A heating rate of 1.0 K/min was used in these calculations. The results are indicated in the Table below.

| Vent area/volume ratio (m²/m³) | Maximum recorded pressure (barg) |
|---|---|
| 100 · 10⁻³ | 0.1 |
| 77.0 · 10⁻³ | 0.1 |
| 57.0 · 10⁻³ | 0.1 |
| 39.3 · 10⁻³ | 17 |
| 25.1 · 10⁻³ | 59 |
| 14.0 · 10⁻³ | 95 |

Since a stainless steal IBC can stand a pressure of 10 barg, it follows that a stainless steal IBC containing a 40 wt % Trigonox® 25 in isododecane formulation should have a vent area/volume ratio higher than 39.3 m²/m³.

1. A packaged peroxide formulation comprising a container and a liquid peroxide formulation, wherein said container has a volume of at least 50 litres and a vent area/volume ratio of at least 20·10⁻³ m²/m³, said liquid peroxide formulation satisfies the classification tests for organic peroxide type F, has a conductivity of at least 100 pS/m, is not an emulsion or suspension, and comprises at least 33 wt % of an organic peroxide selected from the group consisting of diacyl peroxides, peroxyesters, peroxydicarbonates, peroxyketals, and monoperoxycarbonates, and the packaged peroxide formulation has a vent area that is at least equal to the minimum total vent area as determined by the 10 litre venting test.

2. Packaged peroxide formulation according to claim 1 wherein the container has a volume in the range 200-10,000 litres.

3. Packaged peroxide formulation according to claim 1 wherein the vent area/volume ratio of the container is at least 50·10⁻³ m²/m³.

4. Packaged peroxide formulation according to claim 3 wherein the vent area/volume ratio is at least 100·10⁻³ m²/m³.

5. Packaged peroxide formulation according to claim 1 wherein the organic peroxide is a peroxyester or a diacyl peroxide.

6. Packaged peroxide formulation according to claim 5 wherein the organic peroxide is a peroxyester.

7. Packaged peroxide formulation according to claim 3 wherein the phlegmatiser is selected from the group consisting of paraffinic and white oils, n-paraffins, iso-paraffins, aromatic hydrocarbons, ethers, epoxides, and esters.

8. Packaged peroxide formulation according to claim 1 wherein the conductivity of the liquid peroxide formulation is at least 1,000 pS/m.

9. Packaged peroxide formulation according to claim 8 wherein the conductivity of the liquid peroxide formulation is at least 10,000 pS/m.

10. Packaged peroxide formulation according claim 1 wherein the organic peroxide concentration in the liquid peroxide formulation is in the range of 35-90 wt %.

11. A method to produce a polymer by means of a radical polymerisation process using organic peroxide as a source of free radicals, the method comprising transporting a packaged peroxide formulation according to claim 1 to a polymerisation unit and introducing the liquid peroxide formulation into the polymerisation process.

12. A method to modify a (co)polymer comprising transporting a packaged peroxide formulation according to claim 1 to a polymer modification unit and introducing the liquid peroxide formulation into the process.

13. Packaged peroxide formulation according to claim 1 wherein the liquid peroxide formulation further comprises a phlegmatiser.

14. Packaged peroxide formulation according to 2 wherein the vent area/volume ratio of the container is at least 50·10⁻³ m²/m³.

15. Packaged peroxide formulation according to 13 wherein the vent area/volume ratio of the container is at least 50·10⁻³ m²/m³.

16. Packaged peroxide formulation according to claim 2 wherein the organic peroxide is a peroxyester or a diacyl peroxide.

17. Packaged peroxide formulation according to claim 13 wherein the organic peroxide is a peroxyester or a diacyl peroxide.

18. Packaged peroxide formulation according to claim 5 wherein the conductivity of the liquid peroxide formulation is at least 1,000 pS/m.

19. Packaged peroxide formulation according to claim 13 wherein the conductivity of the liquid peroxide formulation is at least 1,000 pS/m.

20. Packaged peroxide formulation according to claim 8 wherein the organic peroxide concentration in the liquid peroxide formulation is in the range of 35-90 wt %.
